(19) United States
(12) Patent Application Publication
(10) Pub. No.: US 2026/0161129 A1
(43) Pub. Date: Jun. 11, 2026

(54) IMAGE FORMING APPARATUS

(71) Applicant: CANON KABUSHIKI KAISHA, Tokyo (JP)

(72) Inventor: YUSUKE SAITO, Shizuoka (JP)

(21) Appl. No.: 19/413,344

(22) Filed: Dec. 9, 2025

(30) Foreign Application Priority Data
Dec. 10, 2024 (JP) 2024-215484

(51) Int. Cl. G03G 15/00; G03G 15/02; G03G 15/06; G03G 15/08

(52) U.S. Cl. CPC G03G 15/80; G03G 15/0216; G03G 15/0266; G03G 15/0283; G03G 15/065; G03G 15/0808; G03G 15/0812; G03G 15/50

(57) ABSTRACT

An image forming apparatus includes a controller for outputting a signal to switch a potential difference. A first coupling connected in series to an output terminal of the controller allows only the signal with a first frequency or higher to pass through, and a second coupling connected in series to the output terminal allows only the signal with a second frequency, lower than the first frequency, or higher to pass through. A first switch connected in series to the first coupling switches the potential difference by receiving the signal passed through the first coupling, and a second switch connected in series to the second coupling switches the potential difference by receiving the signal passed through the second coupling. The controller switches the potential difference to either of three or more kinds of values by changing a frequency of the signal outputted to the first and second couplings.

### BACKGROUND

### Field of the Technology

The present disclosure relates to an image forming apparatus utilizing an electrophotographic type.

### Description of the Related Art

For example, in Japanese Patent Application Laid-Open No. 2014-238490, a charging voltage to be applied to a charging roller is generated by a transformer, and by the charging voltage being divided by a resistor and a switching element, a developing voltage to be applied to a developing roller is generated. In addition, for example, in Japanese Patent Application Laid-Open No. 2018-013720, a blade voltage to be applied to a developing blade is generated by a transformer, and by the blade voltage being divided by a Zener diode and a resistor, a developing voltage is generated. Incidentally, the developing blade is configured to make toner on a surface of the developing roller uniform by being in contact and sliding with the developing roller.

By combining the configuration disclosed in Japanese Patent Application Laid-Open No. 2014-238490 and the configuration disclosed in Japanese Patent Application Laid-Open No. 2018-013720, the following configuration can be considered. That is, a configuration in which a charging voltage is generated by a transformer, and by the charging voltage being divided by a series circuit of a resistor, a Zener diode and a switching element, a blade voltage is generated, and furthermore, by the blade voltage being divided by a Zener diode and a switching element, a developing voltage is generated, can be considered. Such a configuration has characteristics that upon the charging voltage being output, a potential difference between the developing roller and the developing blade is uniquely determined.

### SUMMARY

In a case in which a potential difference between a developing roller and a developing blade always has a constant value, depending on a use environment and a use condition, there is a risk of occurrence of image defect due to melting and adhering of toner to the developing blade. The present disclosure is conceived under such a background, and a purpose of the present disclosure is, with an inexpensive circuit configuration, to switch a potential difference between a developing roller and a developing blade.

In order to solve the aforementioned problems, the present disclosure includes the following configuration.

(1) An image forming apparatus comprising: a photosensitive member on which an electrostatic latent image is formed; a developing roller configured to develop the electrostatic latent image by supplying toner to the photosensitive member; a contacting member configured to contact a surface of the developing roller; and an electronic power source configured to output a first voltage, wherein a second voltage generated by using the first voltage is applied to the developing roller, wherein a third voltage generated by using the second voltage is applied to the contacting member, wherein the electric power source includes a control portion provided with an output terminal for outputting a signal to switch a potential difference between the second voltage and the third voltage, a first coupling portion connected in series to the output terminal and configured to allow only the signal with a first frequency or higher to pass through, a second coupling portion connected in series to the output terminal and configured to allow only the signal with a second frequency, lower than the first frequency, or higher to pass through, a first switching circuit connected in series to the first coupling portion and configured to switch the potential difference by receiving the signal which has passed through the first coupling portion, and a second switching circuit connected in series to the second coupling portion and configured to switch the potential difference by receiving the signal which has passed through the second coupling portion, wherein the control portion switches the potential difference to any of three or more kinds of values by changing a frequency of the signal outputted to the first coupling portion and the second coupling portion.

Further features of the present invention will become apparent from the following description of exemplary embodiments with reference to the attached drawings. The following description of embodiments is described by way of example.

### BRIEF DESCRIPTION OF THE DRAWINGS

FIG. 1 is a configuration view of an image forming apparatus in Embodiments 1 and 2.

FIG. 2 is a circuit diagram of an imaging portion in the Embodiment 1.

FIG. 3, part (a), part (b), part (c) and part (d), includes views showing characteristics of each output voltage in the Embodiment 1.

FIG. 4, part (a) and part (b), includes views showing a frequency of a pulse signal and states of transistors in the Embodiment 1.

FIG. 5 is a view illustrating a Modified Example of a blade circuit in the Embodiment 1.

FIG. 6 is a circuit diagram of an imaging portion in the Embodiment 2.

FIG. 7 is a view showing a frequency of a pulse signal and states of transistors in the Embodiment 2.

FIG. 8 is a view showing characteristics of a blade voltage in the Embodiment 2.

### DESCRIPTION OF THE EMBODIMENTS

### Embodiment 1

### Configuration of an Image Forming Apparatus

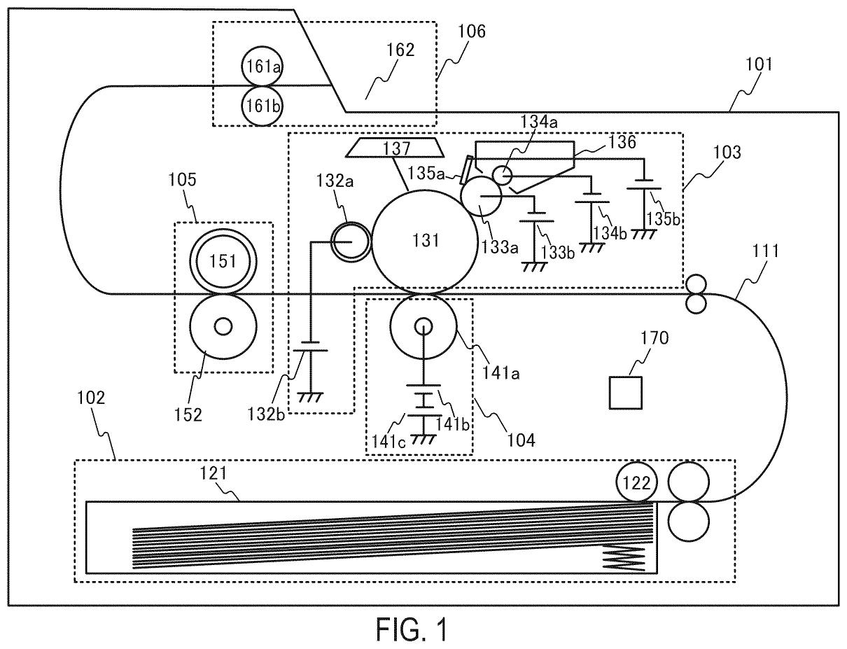

An Embodiment 1 of the present disclosure will be described. In FIG. 1, a cross-sectional view of an image forming apparatus 101 is shown. A sheet feeding portion 102 includes a sheet feeding tray 121 and a sheet feeding roller 122, and in the sheet feeding tray 121, papers which are printing target are stored. An imaging portion 103 is constituted by a photosensitive drum 131 as a photosensitive member, a charging roller 132a, a developing roller 133a, a supplying roller 134a, a developing blade 135a, a toner container 136, a laser scanner 137, etc. The developing roller 133a is a roller which is in contact with the photosensitive drum 131 and carries toner for visualizing an electrostatic latent image on the photosensitive drum 131, and develops the electrostatic latent image by supplying the toner to the photosensitive drum 131. The developing blade 135a as a contacting member is in contact with the developing roller 133a, and adjusts an amount of the toner which the developing roller 133a carries.

To the charging roller 132a, a high voltage generated by a charging circuit 132b can be applied. Similarly, high voltages generated by a developing circuit 133b can be applied to the developing roller 133a, generated by a supplying roller circuit 134b to the supplying roller 134a, and generated by a blade circuit 135b to the developing blade 135a, respectively.

A transfer portion 104 includes a transfer roller 141a, and a high voltage generated by a transfer positive circuit 141b and a transfer negative circuit 141c connected in series to the transfer positive circuit 141b can be applied to the transfer roller 141a. Here, the transfer negative circuit 141c may be connected in parallel with the transfer positive circuit 141b and a connection to the transfer roller 141a may be switched by a switching means such as a switch, or the transfer negative circuit 141c itself may be omitted. In addition, the transfer roller 141a is opposing and in contact with the photosensitive drum 131. A fixing portion 105 includes a fixing roller 151 and a pressing roller 152. In addition, a discharging portion 106 includes discharging rollers 161a and 161b and a discharge tray 162. In addition, inside the image forming apparatus 101, an environment sensor 170 for detecting a temperature and a humidity under which the image forming apparatus 101 is used is disposed.

### Operation of the Image Forming Apparatus

First, operation for forming a toner image on a surface of the photosensitive drum 131 by the imaging portion 103 will be described. The charging roller 132a, to which the negative high voltage is applied from the charging circuit 132b, charges the surface of the photosensitive drum 131. In a charging process in the Embodiment 1, a roller charging type is employed. The charging roller 132a and the photosensitive drum 131 are facing each other with a small gap, and the charging roller 132a charges the surface of the photosensitive drum 131 by utilizing electric discharge between the gap.

The laser scanner 137 irradiates the photosensitive drum 131 with a laser according to image data, and forms the electrostatic latent image on the surface of the photosensitive drum 131. The toner stored in the toner container 136 is negatively charged by agitation. The toner is moved, by the supplying roller 134a to which the negative high voltage is applied from the supplying roller circuit 134b, to the surface of the developing roller 133a and adhered thereto. The toner adhered on the surface of the developing roller 133a has uneven heights from place to place, so that the toner is flattened evenly by the developing blade 135a, to which the negative high voltage is applied by the blade circuit 135b. The developing roller 133a, of which the toner is adhered to the surface, by utilizing the negative high voltage applied from the developing circuit 133b, moves the toner to the surface of the photosensitive drum 131, and the electrostatic latent image is developed.

Here, by setting an absolute value of an output voltage of the supplying roller circuit 134b to be larger than an absolute value of an output voltage of the developing circuit 133b, it becomes easier for the toner, which is negatively charged, to be moved to the developing roller 133a. In addition, by setting an absolute value of the output voltage of the blade circuit 135b to be larger than the absolute value of the output voltage of the developing circuit 133b, it becomes less likely for the toner, which is negatively charged, to be fixedly adhered to the developing blade 135a. For example, the output voltage of the developing circuit 133b is set to −350 V, and the output voltages of the supplying roller circuit 134b and the blade circuit 135b are set to −500 V.

Next, operation for image formation onto the paper will be described. When the image forming apparatus 101 receives a print job, each roller and the laser scanner 137 begin operation thereof, respectively. The paper stored in the sheet feeding tray 121 is fed by the sheet feeding roller 122, passes through a conveyance path 111, and eventually reaches a position at which the photosensitive drum 131 and the transfer roller 141a oppose each other (transfer nip portion). The paper is nipped by the photosensitive drum 131 and the transfer roller 141a, to which a positive high voltage is applied from the transfer positive circuit 141b, and at that time, the toner image formed on the surface of the photosensitive drum 131 is transferred to the paper. The paper which keeps being conveyed next reaches the fixing portion 105, is pressed and nipped by the fixing roller 151 and the pressing roller 152, and the toner image is fixed to the paper. Thereafter, the paper is discharged, through the discharge rollers 161a and 161b, to the discharge tray 162.

### Configurations and Operation of the High Voltage Generating Circuits

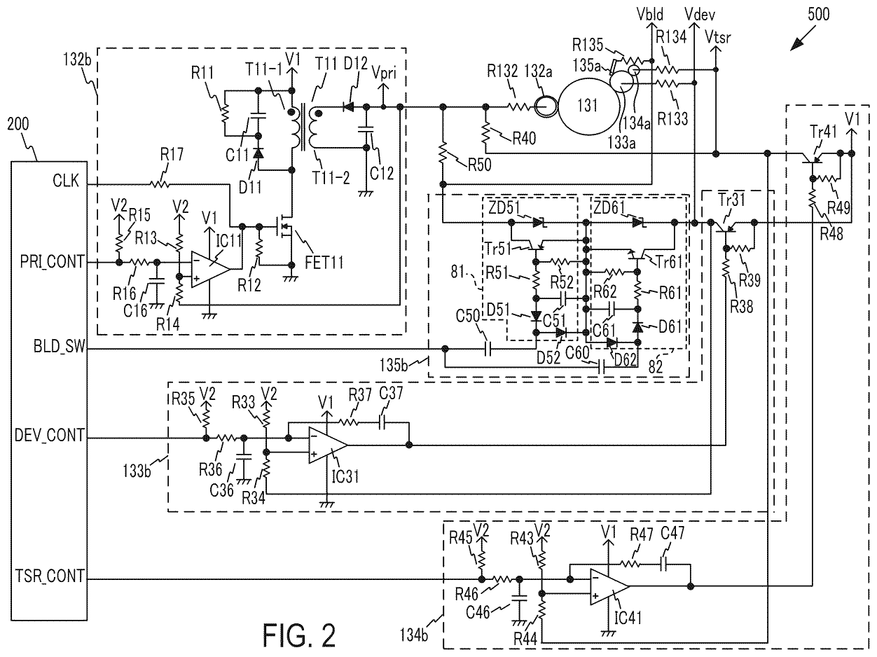

In the imaging portion 103, configurations and operation of the charging circuit 132b, the developing circuit 133b, the supplying roller circuit 134b and the blade circuit 135b will be described using FIG. 2. Incidentally, the charging circuit 132b, the developing circuit 133b, the supplying roller circuit 134b and the blade circuit 135b are included in an electronic power source 500. Here, the electronic power source 500 includes a control portion 200 provided with an output terminal for outputting a signal to switch a potential difference between a charging voltage Vpri and a developing voltage Vdev, which will be described below. The electronic power source 500 also includes a first coupling portion connected in series to the output terminal of the control portion 200 and configured to allow only the signal with a first frequency or higher to pass through. In addition, the electronic power source 500 also includes a second coupling portion connected in series to the output terminal of the control portion 200 and configured to allow only the signal with a second frequency, lower than the first frequency, or higher to pass through. In addition, the electronic power source 500 includes a first switching circuit connected in series to the first coupling portion and configured to switch the potential difference by receiving the signal which has passed through the first coupling portion. Furthermore, the electronic power source 500 includes a second switching circuit connected in series to the second coupling portion and configured to switch the potential difference by receiving the signal which has passed through the second coupling portion. Hereinafter, it will be described in detail.

### Charging Circuit

A transformer T11 is constituted by a primary winding T11-1 and a secondary winding T11-2, and an electronic power source voltage V1 is connected to one terminal of the primary winding T11-1 and a field effect transistor (hereinafter, referred to as an FET) 11 is connected to the other terminal thereof. Between a gate terminal and a source terminal of the FET 11, a resistor R12 is connected. In addition, the gate terminal of the FET 11 is connected, via a resistor R17, to a CLK terminal of the control portion 200.

A capacitor C11 and a resistor R11 are connected in parallel and constitute a parallel circuit, and a diode D11 is connected in series to the parallel circuit. The circuit in which the parallel circuit and the diode D11 are connected in series is connected between both terminals of the primary winding T11-1. On the other hand, between both terminals of the secondary winding T11-2, a diode D12 and a capacitor C12 are connected. A cathode terminal of the diode D12 is connected to one terminal of the secondary winding T11-2 of the transformer T11, an anode terminal of the diode D12 is connected to one terminal of the capacitor C12, and the other terminal of the capacitor C12 is connected to ground (hereinafter, referred to as connected to GND). Incidentally, the electronic power source voltage V1 in the Embodiment 1 is 24 V.

When a signal of high level (hereinafter, also referred to as a Hi state) is output from the CLK terminal of the control portion 200, the FET 11 is turned on, and a drain voltage of the FET 11 drops to substantially the same potential as the GND. As a result, a voltage is applied to both ends of the primary winding T11-1 of the transformer T11, and an excitation current flows. In this state, when the voltage output from the CLK terminal is changed to a low level (hereinafter, also referred to as a Lo state), the FET 11 is turned off. As a result, a flyback voltage is generated at both ends of the primary winding T11-1, and also in the secondary winding T11-2, a flyback voltage according to a turn ratio of the primary winding T11-1 and the secondary winding T11-2 is generated. The flyback voltage generated in the secondary winding T11-2 is rectified and smoothed by the diode D12 and the capacitor C12, and the charging voltage Vpri (first voltage) is generated. Incidentally, the capacitor C11, the resistor R11 and the diode D11 serve as a snubber which absorbs a surge voltage due to a leakage inductance of the primary winding T11-1.

The voltage output from the CLK terminal of the control portion 200 has a rectangular wave in which the Hi state and the Lo state are alternately generated. In the Embodiment 1, a rectangular wave, which has a frequency of 50 kHz and of which an on duty (hereinafter, referred to as a Duty) is fixed to 10%, is output. Incidentally, the frequency and the Duty of the rectangular wave should be designed to optimum values for each circuit, and the values in the Embodiment 1 are only an example. Furthermore, these do not have to be fixed values, but may be configured to be variable depending on a voltage and a load of a control target. By the FET 11 being turned on and off, the flyback voltage generated in the secondary winding T11-2 is rectified and smoothed by the diode D12 and the capacitor C12, the charging voltage Vpri is generated.

The charging circuit 132b performs feedback control, in order to control the charging voltage Vpri to a stable and desired voltage, to the charging voltage Vpri. The charging voltage Vpri is connected, via a resistor R14 and a resistor R13, to an electronic power source voltage V2. A connected point of the resistor R14 and the resistor R13 is connected to a positive input terminal of a comparator IC11. A negative input terminal of the comparator IC11 is connected, via a resistor R16 and a resistor R15, to the electronic power source voltage V2, and additionally connected, via a capacitor C16, to the GND. A connected point of the resistor R15 and the resistor R16 is connected to a PRI_CONT terminal of the control portion 200. In addition, an output terminal of the comparator IC11 is connected to the gate terminal of the FET 11.

From the PRI_CONT terminal, a pulse signal which alternately repeats a high impedance (hereinafter, referred to as a Hi-Z) state and a Lo state is output. When the PRI_CONT terminal is in the Hi-Z state, from the electronic power source voltage V2 via the resistor R15 and the resistor R16, a current which charges the capacitor C16 flows. On the other hand, when the PRI_CONT terminal is in the Lo state, a current which discharges the capacitor C16 flows via the resistor R16 toward the PRI_CONT terminal. By the PRI_CONT terminal repeating the Hi-Z state and the Lo state, balance between the charging and the discharging of the capacitor C16 is stabilized at a predetermined voltage. Therefore, depending on the Duty of the pulse signal output from the PRI_CONT terminal, the voltage of the negative input terminal of the comparator IC11 is determined.

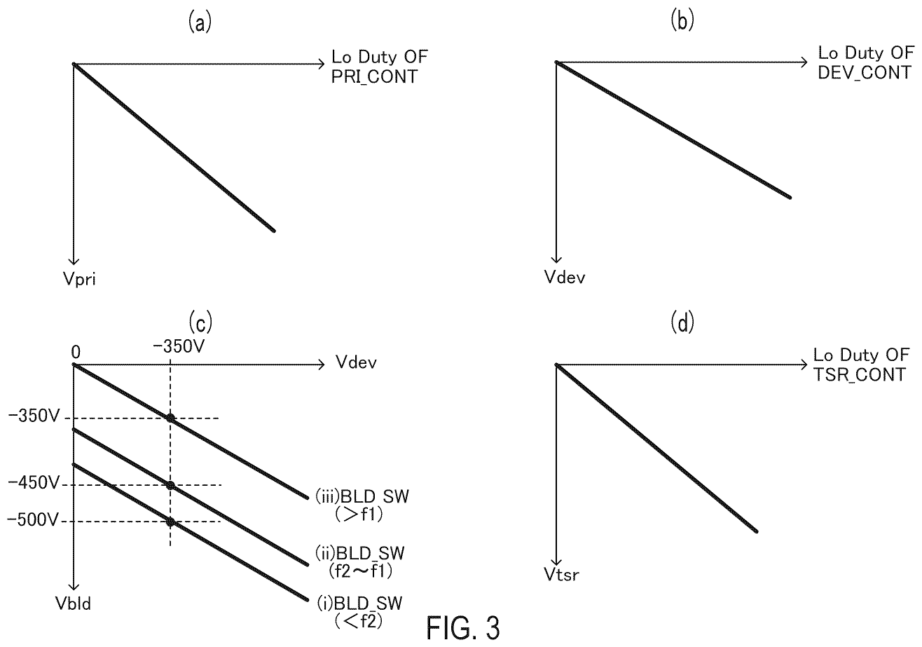

Specifically, as shown in part (a) of FIG. 3, the higher an off duty (hereinafter, referred to as a LoDuty) of the pulse signal output from the PRI_CONT terminal, the larger an absolute value of the charging voltage Vpri. In part (a) of FIG. 3, a horizontal axis represents the LoDuty of the pulse signal output from the PRI_CONT terminal, and a vertical axis represents the charging voltage Vpri.

In a case in which the voltage of the negative input terminal of the comparator IC11 is lower than that of the positive input terminal, the output terminal of the comparator IC11 becomes Hi-Z. The signal output from the CLK terminal of the control portion 200 is to drive the FET 11 on and off directly. On the other hand, in a case in which the voltage of the negative input terminal of the comparator IC11 is higher than that of the positive input terminal, the output terminal of the comparator IC11 becomes Lo. The current output from the CLK terminal is drawn by the output terminal of the comparator IC11, and a gate voltage of the FET 11 becomes Lo forcibly. Since the FET 11 cannot be turned on at a timing when it should be turned on, decrease of the absolute value of the charging voltage Vpri is promoted. By this operation, it becomes possible to control the charging voltage Vpri to a desired voltage. Here, the electronic power source voltage V2 in the Embodiment 1 is 5 V. Since the electronic power source voltage V2 affects the voltages of the positive input terminal and the negative input terminal of the comparator IC11, it is necessary to pay attention to a point that for the electronic power source voltage V2, an electronic power source with relatively high voltage accuracy should be used.

Through the operation described above, the stable charging voltage Vpri is generated and applied to the charging roller 132a. Incidentally, a resistor R132 may be included, to limit an output current and for a purpose of ESD (Electro Static Discharge) protection from outside in a state in which the charging roller 132a, which is mountable to and demountable from the image forming apparatus 101, is demounted from the image forming apparatus 101, as necessary. In addition, a value of the charging voltage Vpri in the Embodiment 1 is −1500 V.

### Developing Circuit

The developing circuit 133b is a circuit which generates the developing voltage Vdev (a second voltage) by reducing the charging voltage Vpri through voltage dividing. The developing voltage Vdev is connected, from the charging voltage Vpri, via a resistor R50, a Zener diode ZD51 (first voltage drop element), a Zener diode ZD61 (second voltage drop element) and a transistor Tr31, to the electronic power source voltage V1. A collector terminal of the transistor Tr31 becomes the developing voltage Vdev. In a base terminal of the transistor Tr31, a resistor R39 is connected to an emitter terminal, and a resistor R38 is connected to an output terminal of an operational amplifier IC31.

The developing circuit 133b also performs the feedback control, in order to control the developing voltage Vdev to a stable and desired voltage, to the developing voltage Vdev. The developing voltage Vdev is connected, via a resistor R34 and a resistor R33, to the electronic power source voltage V2. A connected point of the resistor R34 and the resistor R33 is connected to a positive input terminal of the operational amplifier IC31. A negative input terminal of the operational amplifier IC31 is connected, via a resistor R36 and a resistor R35, to the electronic power source voltage V2, and additionally connected, via a capacitor C36, to the GND. A connected point of the resistor R35 and the resistor R36 is connected to a DEV_CONT terminal of the control portion 200. Between the negative input terminal and the output terminal of the operational amplifier IC31, a resistor R37 and a capacitor C37 are connected in series. This is for phase compensation for the operational amplifier IC31, and contributes to stability of the feedback control.

From the DEV_CONT terminal of the control portion 200, a pulse signal, which alternately repeats a Hi-Z state and a Lo state, is output. When the DEV_CONT terminal is in the Hi-Z state, from the electronic power source voltage V2 via the resistor R35 and the resistor R36, a current which charges the capacitor C36 flows. On the other hand, when the DEV_CONT terminal is in the Lo state, a current which discharges the capacitor C36 flows via the resistor R36 toward the DEV_CONT terminal. By the DEV_CONT terminal repeating the Hi-Z state and the Lo state, balance between the charging and the discharging of the capacitor C36 is stabilized at a predetermined voltage. Therefore, depending on a Duty of the pulse signal output from the DEV_CONT terminal, a voltage of the negative input terminal of the operational amplifier IC31 is determined.

In a case in which the voltage of the negative input terminal of the operational amplifier IC31 is lower than that of the positive input terminal, the output terminal of the operational amplifier IC31 becomes Hi. The transistor Tr31 is turned off, and an absolute value of the developing voltage Vdev is increased. On the other hand, in a case in which the voltage of the negative input terminal of the operational amplifier IC31 is higher than that of the positive input terminal, the output terminal of the operational amplifier IC31 becomes Lo. The transistor Tr31 is turned on, and the absolute value of the developing voltage Vdev is decreased. By this operation, it becomes possible to control the developing voltage Vdev to a desired voltage. Specifically, as shown in part (b) of FIG. 3, the larger a LoDuty of the pulse signal output from the DEV_CONT terminal, the larger the absolute value of the developing voltage Vdev. In Part (b) of FIG. 3, a horizontal axis represents the LoDuty of the pulse signal output from the DEV_CONT terminal, and a vertical axis represents the developing voltage Vdev.

Through the operation described above, the stable developing voltage Vdev is generated and applied to the developing roller 133a. Incidentally, a resistor R133 may be included, similarly to the resistor R132, to limit an output current and for a purpose of the ESD protection from outside in a state in which the developing roller 133a is demounted from the image forming apparatus 101, as necessary. In addition, a value of the developing voltage Vdev in the Embodiment 1 is −350 V.

### Blade Circuit

The blade circuit 135b is a circuit which generates a blade voltage Vbld (third voltage) having a predetermined potential difference relative to the developing voltage Vdev. The blade voltage Vbld is connected to the developing voltage Vdev via the Zener diode ZD51 and the Zener diode ZD61, and an anode terminal side of the Zener diode ZD51 is the blade voltage Vbld. In other words, the blade voltage Vbld has an absolute value larger than the developing voltage Vdev by the Zener voltages. Incidentally, a resistor R135 may be included, to limit an output current and for the purpose of the ESD protection, as necessary.

A PNP type transistor Tr51 is connected in parallel to the Zener diode ZD51. The transistor Tr51 functions as a first switching element which short-circuits the Zener diode ZD51 in an on state and generates a potential difference by a first value (100 V) by connecting the Zener diode ZD51 in an off state. An NPN type transistor Tr61 is connected in parallel to the Zener diode ZD61. The transistor Tr61 functions as a second switching element which short-circuits the Zener diode ZD61 in an on state and generates a potential difference by a second value (50 V) by connecting the Zener diode ZD61 in an off state. When the transistor Tr51 is turned on, both terminals of the Zener diode ZD51 are short-circuited, and when the transistor Tr61 is turned on, both terminals of the Zener diode ZD61 are short-circuited.

In other words, in a case in which the transistor Tr51 shifts from a state of receiving the pulse signal to a state of non-receiving the pulse signal, by the transistor Tr51 becoming the off state, the Zener diode ZD51 generates the potential difference by the first value (100 V). In a case in which the transistor Tr51 shifts from the state of non-receiving the pulse signal to the state of receiving the pulse signal, by the transistor Tr51 becoming the on state, the Zener diode ZD51 is short-circuited. In a case in which the transistor Tr61 shifts from a state of receiving the pulse signal to a state of non-receiving the pulse signal, by the transistor Tr61 becoming the off state, the Zener diode ZD61 generates the potential difference by the second value (50 V). In a case in which the transistor Tr61 shifts from the state of non-receiving the pulse signal to the state of receiving the pulse signal, by the transistor Tr61 becoming the on state, the Zener diode ZD61 is short-circuited.

Therefore, the blade circuit 135b can switch the potential difference of the blade voltage Vbld relative to the developing voltage Vdev by controlling the on and off of the transistor Tr51 and/or the transistor Tr61.

A base terminal of the transistor Tr51 is connected via a resistor R52 to an emitter terminal thereof. The base terminal of the transistor Tr51 is connected via a resistor R51 to an anode terminal of a diode D51. A cathode terminal of the diode D51 is connected to an anode terminal of a diode D52, and a cathode terminal of the diode D52 is connected to the emitter terminal of the transistor Tr51. To the resistor R51 and the resistor R52, a capacitor C51 is connected in parallel. The cathode terminal of the diode D51 is connected via a capacitor C50 to a BLD_SW terminal of the control portion 200. From the BLD_SW terminal, a pulse signal, which alternately repeats a Hi state and a Lo state, is output.

The pulse signal output from the BLD_SW terminal is rectified, via the capacitor C50, by the diode D51 and the diode D52. By the rectified current, electric charge is charged to the capacitor C51, and it becomes a state in which a base current stably flows out from the base terminal of the transistor Tr51. When the base current flows stably from the base terminal of the transistor Tr51, the transistor Tr51 is turned on, and both terminals of the Zener diode ZD51 are short-circuited.

Similarly, a base terminal of the transistor Tr61 is connected via a resistor R62 to an emitter terminal thereof. The base terminal of the transistor Tr61 is connected via a resistor R61 to a cathode terminal of a diode D61. An anode terminal of the diode D61 is connected to a cathode terminal of a diode D62, and an anode terminal of the diode D62 is connected to the emitter terminal of the transistor Tr61. To the resistor R61 and the resistor R62, a capacitor C61 is connected in parallel. The anode terminal of the diode D61 is connected via a capacitor C60 to the BLD_SW terminal of the control portion 200. From the BLD_SW terminal, the pulse signal, which alternately repeats the Hi state and the Lo state, is output.

The pulse signal output from the BLD_SW terminal is rectified, via the capacitor C60, by the diode D61 and the diode D62. By the rectified current, electric charge is charged to the capacitor C61, and it becomes a state in which a base current stably flows out from the base terminal of the transistor Tr61. When the base current flows stably from the base terminal of the transistor Tr61, the transistor Tr61 is turned on, and both terminals of the Zener diode ZD61 are short-circuited. The emitter terminal of the transistor Tr51 and the emitter terminal of the transistor Tr61 are connected to each other.

Here, the Zener diode ZD51, the transistor Tr51, the resistors R51 and R52, the diodes D51 and D52 and the capacitor C51 are included in a switching circuit 81 as the first switching circuit which switches the potential difference between the blade voltage Vbld and the developing voltage Vdev. In a case in which the switching circuit 81 shifts from a state of receiving the pulse signal to a state of non-receiving the pulse signal, the switching circuit 81 switches the potential difference so that the potential difference is increased by the first value (100 V). In a case in which the switching circuit 81 shifts from the state of non-receiving the pulse signal to the state of receiving the pulse signal, the switching circuit 81 switches the potential difference so that the potential difference is decreased by the first value (100 V).

In addition, the Zener diode ZD61, the transistor Tr61, the resistors R61 and R62, the diodes D61 and D62 and the capacitor C61 are included in a switching circuit 82 as the second switching circuit which switches the potential difference between the blade voltage Vbld and the developing voltage Vdev. In a case in which the switching circuit 82 shifts from a state of receiving the pulse signal to a state of non-receiving the pulse signal, the switching circuit 82 switches the potential difference so that the potential difference is increased by the second value (50 V). In a case in which the switching circuit 82 shifts from the state of non-receiving the pulse signal to the state of receiving the pulse signal, the switching circuit 82 switches the potential difference so that the potential difference is decreased by the second value (50 V).

The Zener diode ZD51 and the Zener diode ZD61 are connected in series, so that it may be said that the switching circuit 81 and the switching circuit 82 are connected in series. The switching circuit 81 generates the potential difference by the first value (100 V), and the switching circuit 82 generates the potential difference by the second value (50 V).

The capacitor C50 as the first coupling portion is connected to the switching circuit 81, and allows the pulse signal with the first frequency or higher to pass through. The capacitor C60 as the second coupling portion is connected to the switching circuit 82, and allows the pulse signal with the second frequency, lower than the first frequency, or higher to pass through. To the capacitor C50 and the capacitor C60, the pulse signal are output from the control portion 200.

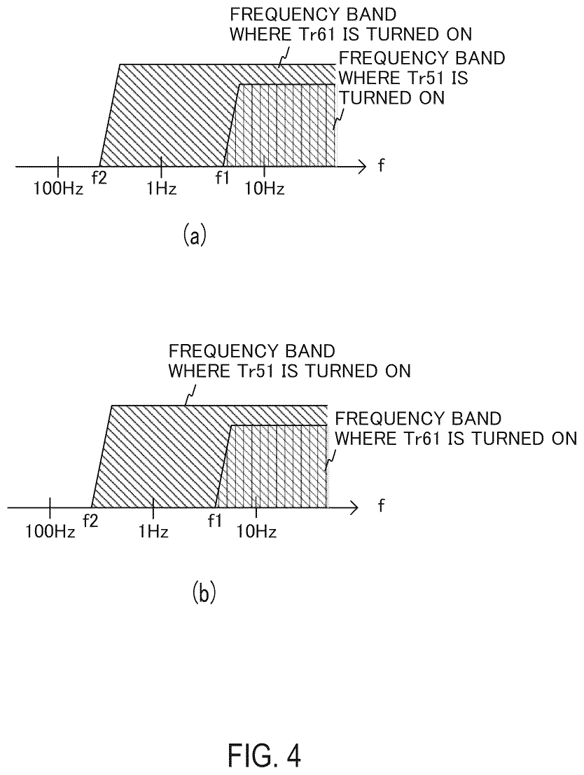

Next, a frequency of the pulse signal output from the BLD_SW terminal and states of the transistor Tr51 and the transistor Tr61 will be described using FIG. 4. As an example, a case in which, between the capacitor C50 and the capacitor C60, a capacitor with a higher self resonant frequency is used for the capacitor C60 will be described.

Generally, for components of the same series, the larger a capacity, the higher the self resonant frequency. For example, a capacitor with 100 pF is used for the capacitor C50, and a capacitor with 1000 pF is used for the capacitor C60. In addition, as an example, a case in which the Zener voltage of 100 V (the first value) is used for the Zener diode ZD51 and the Zener voltage of 50 V (the second value) is used for the Zener diode ZD61 will be described.

Part (a) of FIG. 4 shows, with respect to a frequency f of the pulse signal output from the BLD_SW terminal, the states of the transistor Tr51 and the transistor Tr61. The transistor Tr51 is turned on when the pulse signal with a frequency higher than a predetermined frequency f1 (first frequency) is input to the capacitor C50. The predetermined frequency f1 is determined by characteristics of the capacitor C50. The transistor Tr61 is turned on when the pulse signal with a frequency higher than a predetermined frequency f2 (second frequency) is input to the capacitor C60. Incidentally, in this example, the predetermined frequency f2 is lower than the predetermined frequency f1 (f2<f1). The predetermined frequency f2 is determined by characteristics of the capacitor C60.

### Switching of the Potential Difference by Changing the Frequency

The control portion 200 switches the potential difference between the developing voltage Vdev and the blade voltage Vbld to any of three or more kinds of values by changing the frequency of the pulse signal output to the first coupling portion and the second coupling portion. In other words, the control portion 200 outputs the pulse signal, controls the switching circuit 81 and the switching circuit 82 via the capacitor C50 and the capacitor C60, and switches the potential difference between the developing voltage Vdev and the blade voltage Vbld to any of at least three values. Relationship between the developing voltage Vdev and the blade voltage Vbld is shown in part (c) of FIG. 3. In Part (c) of FIG. 3, a horizontal axis represents a value of the developing voltage Vdev and a vertical axis represents a value of the blade voltage Vbld. (i) through (iii) in part (c) of FIG. 3 correspond to the following (i) through (iii).

### (i) The Transistor Tr51 and the Transistor Tr61 are Off

When the frequency f of the pulse signal output from the BLD_SW terminal is a lower frequency, as shown in part (a) of FIG. 4, than the predetermined frequency f2 (for example, 100 Hz), the transistor Tr51 and the transistor Tr61 are turned off. Therefore, the blade voltage Vbld becomes lower than the developing voltage Vdev by a sum of the Zener voltages of the Zener diode ZD61 and the Zener diode ZD51 (Vbld=Vdev−(100 V+50 V)). In other words, when the developing voltage Vdev is −350 V, the blade voltage Vbld becomes −500 V (=−₃₅₀ V−₁₅₀ V). In addition, also when the pulse signal is not output or when the pulse signal is the Low output (Lo state) or the High output (Hi state), it becomes the state of (i) described above.

### (ii) The Transistor Tr51 is Off and the Transistor Tr61 is On

When the frequency f of the pulse signal output from the BLD_SW terminal is the predetermined frequency f2 or a higher frequency and a lower frequency than the predetermined frequency f1 (for example, 1 kHz), the transistor Tr51 is turned off and the transistor Tr61 is turned on. Since the Zener diode ZD61 is short-circuited, the blade voltage Vbld becomes lower than the developing voltage Vdev by the Zener voltage of the Zener diode ZD51 (Vbld=Vdev−100 V). In other words, when the developing voltage Vdev is −350 V, the blade voltage Vbld becomes −450 V.

(iii) The Transistor Tr51 is On and the Transistor Tr61 is On

When the frequency f of the pulse signal output from the BLD_SW terminal is a higher frequency than the predetermined frequency f1 and the predetermined frequency f2 (for example, 10 kHz), the transistor Tr51 is turned on and the transistor Tr61 is turned on. Since the Zener diode ZD51 and the Zener diode ZD61 are short-circuited, the blade voltage Vbld becomes the same potential as the developing voltage Vdev (Vbld=Vdev). In other words, when the developing voltage Vdev is −350 V, the blade voltage Vbld becomes −350 V. In this manner, the blade voltage Vbld takes the values of which an absolute value is an absolute value of the developing voltage Vdev or higher (|Vbld|≥|Vdev|) depending on the frequency f of the pulse signal output from the BLD_SW terminal.

In addition, to a connected point between the capacitor C50 and the cathode terminal of the diode D51, a high voltage is applied. In general, in the control portion 200, much of components are of low withstand voltage, so that it is not possible to connect the pulse signal directly from the control portion 200 to the diode D51. By using a capacitor with high withstand voltage for the capacitor C50, it also has an effect of preventing the high voltage from being applied to the control portion 200. The capacitor C60 serves in the same manner.

### On Potential Difference Depending on Use Environment

By the way, an optimal potential difference between the developing voltage Vdev and the blade voltage Vbld varies depending on the use environment. For example, in a high temperature and high humidity environment, if a larger potential difference than necessary continues to be applied, the toner may be melted and adhered to the developing blade 135a, and it may result in image defect. Thus, in the Embodiment 1, if values detected by the environment sensor 170 indicate a normal environment, then it is used in the state of (i) described above. Incidentally, a temperature in the normal environment is defined as a predetermined temperature and a humidity in the normal environment is defined as a predetermined humidity. If the detection results of the environment sensor 170 are the predetermined temperature and the predetermined humidity, the control portion 200 controls the frequency f of the pulse signal output from the BLD_SW terminal to be lower than the predetermined frequency f2 (for example, 100 Hz). As a result, the transistor Tr51 and the transistor Tr61 are turned off.

In addition, if the values detected by the environment sensor 170 indicate that it is the environment higher than the predetermined temperature and the predetermined humidity (high temperature and high humidity environment), it is used in the state of (ii) described above. If the detection results of the environment sensor 170 are higher than the predetermined temperature and higher than the predetermined humidity, the control portion 200 controls the frequency f of the pulse signal output from the BLD_SW terminal to be the predetermined frequency f2 or higher and lower than the predetermined frequency f1 (for example, 1 kHz). As a result, the transistor Tr51 is turned off and the transistor Tr61 is turned on.

As a result, upon the normal environment, since the developing voltage Vdev is −350 V and the blade voltage is −500 V, the potential difference between the developing voltage Vdev and the blade voltage Vbld becomes 150 V. On the other hand, in the high temperature and high humidity environment, since the developing voltage Vdev is −350 V and the blade voltage is −450 V, the potential difference between the developing voltage Vdev and the blade voltage Vbld becomes 100 V. By setting the potential difference between the developing voltage Vdev and the blade voltage Vbld in the high temperature and high humidity environment to a smaller potential difference than in the normal environment, it becomes possible to suppress the melting and adhesion of the toner to the developing blade 135a. Incidentally, in this example, the frequency of the pulse signal is changed depending on the temperature and the humidity, however, the frequency may be changed depending on the temperature or depending on the humidity. In addition, the frequency of the pulse signal may be changed depending on a measurement result of other indicators which indicates the use environment.

As described above, the image forming apparatus 101 is provided with the environment sensor 170 which detects the temperature and/or the humidity. The control portion 200 changes the frequency of the pulse signal depending on the detection result of the environment sensor 170. For example, the control portion 200 switches the frequency of the pulse signal so that the absolute value of the potential difference between the developing voltage Vdev and the blade voltage Vbld is smaller than the absolute value of the potential difference upon the predetermined value in the case in which the value detected by the environment sensor 170 is higher than the predetermined value. More specifically, the control portion 200 sets, in the case in which the value detected by the environment sensor 170 is the predetermined value or smaller, the frequency of the output pulse signal to be lower than the second frequency, and switches so that the potential difference is the sum of the first value (100 V) and the second value (50 V). In addition, for example, in the case in which the value detected by the environment sensor 170 is greater than the predetermined value, the control portion 200 sets the frequency of the output pulse signal to be the second frequency or higher and lower than the first frequency, and switches so that the potential difference is the first value (100 V).

### On the Potential Difference in a Case in Which Rotation of the Developing Roller is Stopped

In addition, in a state in which rotation of the developing roller 133a is stopped, if the potential difference continues to be generated between the developing roller 133a and the developing blade 135a for a long period of time, a contact portion may become a different state from a non-contact portion, and image defect such as streaks may occur. Therefore, when the rotation of the developing roller 133a is stopped, by using the state of (iii) described above, it is also possible to set the potential difference between the developing roller 133a and the developing blade 135a to 0 V. In the case in which the developing roller 133a and the developing blade 135a are not used, the control portion 200 controls the frequency f of the pulse signal output from the BLD_SW terminal to be the predetermined frequency f1 or higher (for example, 10 kHz). As a result, the transistor Tr51 and the transistor Tr61 are turned on.

Through the operation described above, for the developing blade 135a, it becomes possible to use with switching among the three kinds of voltages. That is, those are the three kinds of voltages of the same voltage as the developing voltage Vdev, the voltage whose absolute value is greater than that of the developing voltage Vdev by the sum of the Zener voltages of the Zener diode ZD51 and the Zener diode ZD61, and the voltage whose absolute value is greater than that the developing voltage Vdev by the Zener voltage of the Zener diode ZD51.

### Supplying Roller Circuit

The supplying roller circuit 134b is a circuit which generates a supplying roller voltage Vtsr by lowering the charging voltage Vpri by voltage dividing, and has substantially the same configuration as the developing circuit 133b. The supplying roller circuit 134b is connected from the charging voltage Vpri via a resistor R40 and a transistor Tr41 to the electronic power source voltage V1, and a collector terminal of the transistor Tr41 becomes the supplying roller voltage Vtsr. In a base terminal of the transistor Tr41, a resistor R49 is connected to an emitter terminal thereof, and a resistor R48 is connected to an output terminal of an operational amplifier IC41.

Also in the supplying roller circuit 134b, in order to control the supplying roller voltage Vtsr to a stable and desired voltage, feedback control is performed to the supplying roller voltage Vtsr. The supplying roller voltage Vtsr is connected, via a resistor R44 and a resistor R43, to the electronic power source voltage V2. A connected point of the resistor R44 and the resistor R43 is connected to a positive input terminal of the operational amplifier IC41. A negative input terminal of the operational amplifier IC41 is connected, via a resistor R46 and a resistor R45, to the electronic power source voltage V2, and additionally connected, via a capacitor C46, to the GND. A connected point of the resistor R45 and the resistor R46 is connected to a TSR_CONT terminal of the control portion 200. Between the negative input terminal and the output terminal of the operational amplifier IC41, a resistor R47 and a capacitor C47 are connected in series. This is for phase compensation for the operational amplifier IC41, and contributes to stability of the feedback control.

From the TSR_CONT terminal, the pulse signal which alternately repeats a Hi-Z state and a Lo state is output. When the TSR_CONT terminal is in the Hi-Z state, from the electronic power source voltage V2 via the resistor R45 and the resistor R46, a current which charges the capacitor C46 flows. On the other hand, when the TSR_CONT terminal is in the Lo state, a current which discharges the capacitor C46 flows via the resistor R46 toward the TSR_CONT terminal. By the TSR_CONT terminal repeating the Hi-Z state and the Lo state, balance between the charging and the discharging of the capacitor C46 is stabilized at a predetermined voltage.

Therefore, depending on a Duty of the pulse signal output from the TSR_CONT terminal, a voltage of the negative input terminal of the operational amplifier IC41 is determined. In a case in which the voltage of the negative input terminal of the operational amplifier IC41 is lower than that of the positive input terminal, the output terminal of the operational amplifier IC41 becomes Hi. The transistor Tr41 is turned off and an absolute value of the supplying roller voltage Vtsr is increased. On the other hand, in a case in which the voltage of the negative input terminal of the operational amplifier IC41 is higher than that of the positive input terminal, the output terminal of the operational amplifier IC41 becomes Lo. The transistor Tr41 is turned on and the absolute value of the supplying roller voltage Vtsr is decreased. By this operation, it becomes possible to control the supplying roller voltage Vtsr to a desired voltage. Specifically, as shown in part (d) of FIG. 3, the larger a LoDuty of the pulse signal output from the TSR_CONT terminal, the larger the absolute value of the supplying roller voltage Vtsr. In part (d) of FIG. 3, a horizontal axis represents the LoDuty of the pulse signal output from the TSR_CONT terminal, and a vertical axis represents the supplying roller voltage Vtsr.

Through the operation described above, the stable supplying roller voltage Vtsr is generated and applied to the supplying roller 134a. Incidentally, a resistor R134 may be included, as in the same manner as the resistor R132, the resistor R133 and the resistor R135, as necessary. In addition, a value of the supplying roller voltage Vtsr in the Embodiment 1 is −500 V.

As described above, in the Embodiment 1, the following three kinds of voltages can be used for the developing blade 135a with switching depending on the use environment. In other words, those are the three kinds of voltages of the same voltage as the developing voltage Vdev, the voltage whose absolute value is greater than that of the developing voltage Vdev by the sum of the Zener voltages of the Zener diode ZD51 and the Zener diode ZD61, and the voltage whose absolute value is greater than that of the developing voltage Vdev by the zener voltage of the Zener diode ZD51.

In other words, the control portion 200 sets the frequency of the output pulse signal to be lower than the second frequency (f<f2). By this, the control portion 200 switches, with the switching circuits 81 and 82, so that the potential difference between the developing voltage Vdev and the blade voltage Vbld is the sum (100 V+50 V) of the first value (100 V) and the second value (50 V). More specifically, the control portion 200 causes, by setting the frequency of the output pulse signal to be lower than the second frequency, the transistor Tr51 and the transistor Tr61 to be the off state, and switches so that the potential difference is the sum of the first value (100 V) and the second value (50 V). In addition, the control portion 200 switches, by setting the frequency of the output pulse signal to be the second frequency or higher and lower than the first frequency (f2≤f<f1), so that the potential difference is the first value (100 V) with the switching circuits 81 and 82. More specifically, the control portion 200 causes, by setting the frequency of the output pulse signal to be the second frequency or higher and lower than the first frequency, the transistor Tr51 to be the off state and the transistor Tr61 to be the on state, and switches so that the potential difference is the first value (100 V). Furthermore, the control portion 200 switches, by setting the frequency of the output pulse signal to be the first frequency or higher (f≥f1), so that the potential difference is zero with the switching circuits 81 and 82. More specifically, the control portion 200 causes, by setting the frequency of the output pulse signal to be the first frequency or higher, the transistor Tr51 and the transistor Tr61 to be the on state, and switches so that the potential difference is zero. In this manner, by using with switching among the three kinds of voltages depending on the use environment, it becomes possible to suppress the image defect.

In addition, in the case in which the plurality of the Zener diodes are connected in series between the blade voltage Vbld and the developing voltage Vdev to switch the potential difference, by configuring as the switching circuits 81 and 82, it becomes possible to perform the control with a single signal line (BLD_SW terminal). In other words, according to the configuration in the Embodiment 1, in order to control the short-circuit and the connecting of each of the plurality of Zener diodes, the same number of signal lines as the number of Zener diodes are not needed. In the Embodiment 1, by switching the frequency of the pulse signal output from the one BLD_SW terminal of the control portion 200, it becomes possible to switch the potential difference between the blade voltage Vbld and the developing voltage Vdev.

### Modified Example

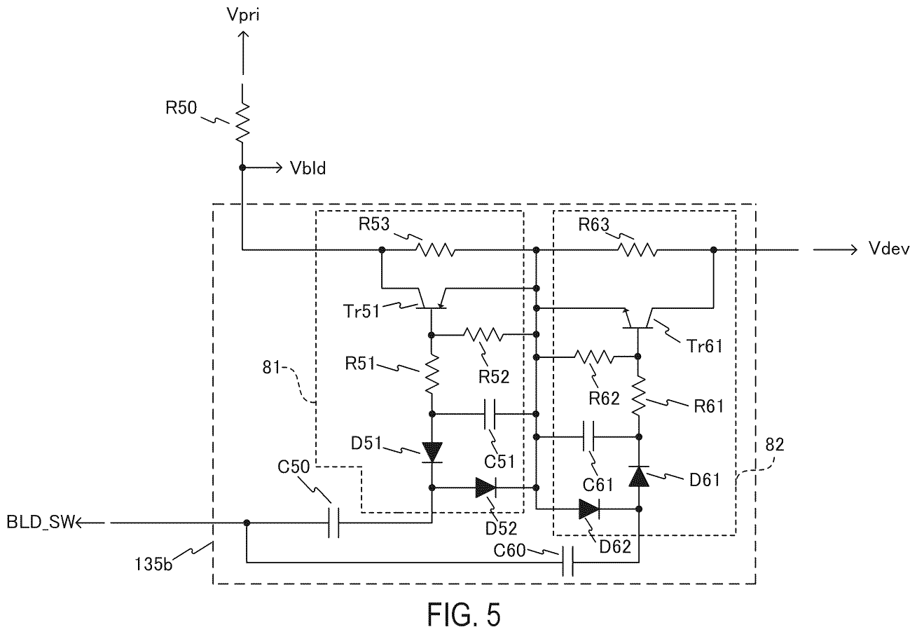

In addition, in the Embodiment 1, in order to generate the potential difference between the developing voltage Vdev and the blade voltage Vbld, the Zener diode ZD51 and the Zener diode ZD61 are used, however, it is not limited thereto. For example, as shown in FIG. 5, resistors may be used instead of the Zener diodes as a Modified Example. In FIG. 5, a resistor R53 (the first voltage drop element) is connected to the position of the Zener diode ZD51 in FIG. 2, and a resistor R63 (the second voltage drop element) is connected to the position of the Zener diode ZD61 in FIG. 2. In this case, a blade voltage Vbld is determined by voltage dividing by a resistor R50, the resistor R53 and the resistor R63.

In more detail, when the frequency f of the pulse signal output from the BLD_SW terminal is lower than the predetermined frequency f2, a transistor Tr51 and a transistor Tr61 are turned off. As a result, the blade voltage Vbld becomes a voltage of a charging voltage Vpri divided by the resistor R50 and a combined resistance of the resistor R53 and the resistor R63.

When the frequency f of the pulse signal output from the BLD_SW terminal is the predetermined frequency f2 or higher and lower than the predetermined frequency f1, the transistor Tr51 is turned off and the transistor Tr61 is turned on. As a result, the blade voltage Vbld becomes a voltage of the charging voltage Vpri divided by the resistor R50 and the resistor R53. When the frequency f of the pulse signal output from the BLD_SW terminal is the predetermined frequency f1 or higher, the transistor Tr51 and the transistor Tr61 are turned on. As a result, the blade voltage Vbld becomes a voltage dropped from the charging voltage Vpri by the resistor R50.

In addition, in the Embodiment 1, upon comparing the capacitor C50 with the capacitor C60, the case in which the capacitor with the higher self resonant frequency is used for the capacitor C60 is described, however, the capacitor with the higher self resonant frequency may be used for the capacitor C50. In this case, the states of the transistor Tr51 and the transistor Tr61 with respect to the frequency of the pulse signal become as shown in part (b) of FIG. 4.

A point that part (b) of FIG. 4 differs from part (a) of FIG. 4 is when the frequency f of the pulse signal output from the BLD_SW terminal is the predetermined frequency f2 or higher and lower than the predetermined frequency f1. At this time in part (b) of FIG. 4, the transistor Tr51 is turned on and the transistor Tr61 is turned off. Thus, when the developing voltage Vdev is −350 V, the blade voltage Vbld becomes −400 V.

In addition, by turning on and off of the transistors Tr51 and Tr61, the states in which both ends of the Zener diodes ZD51 and ZD61 are short-circuited and connected are switched. Incidentally, instead of the transistors Tr51 and Tr61, a switching element such as a field effect transistor (FET) and a photocoupler may be used.

As described above, according to the Embodiment 1, it becomes possible, with the inexpensive circuit configuration, to switch the potential difference between the developing roller and the developing blade.

### Embodiment 2

An Embodiment 2 will be described. The Embodiment 2 differs, with respect to the configuration in the Embodiment 1, in that low pass filters are disposed between a BLD_SW terminal of a control portion 200 and a capacitor C50 and between the BLD_SW terminal of the control portion 200 and a capacitor C60, respectively. In the Embodiment 2, only points which differ from the Embodiment 1 will be described, and the description will be omitted for points which are the same as in the Embodiment 1.

### Blade Circuit

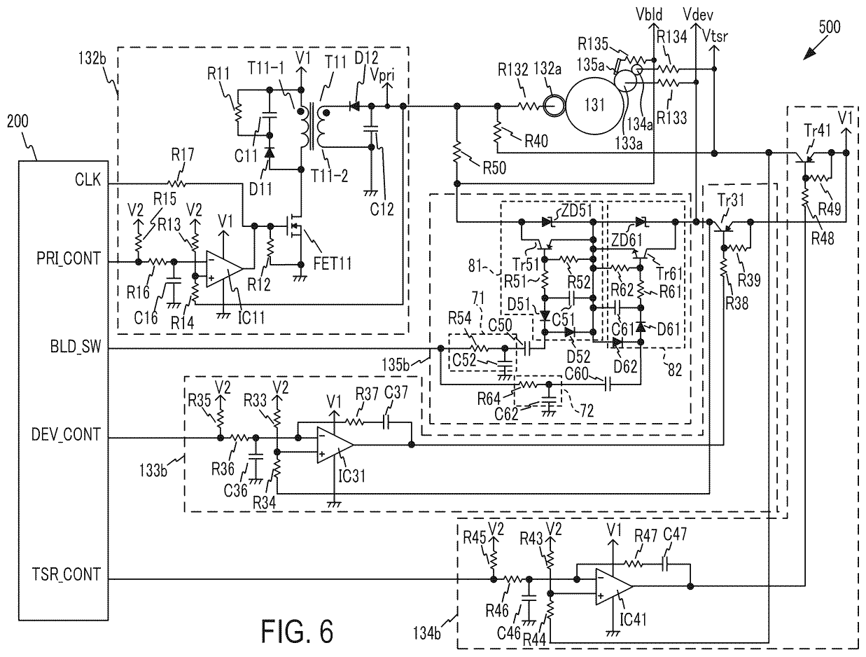

FIG. 6 is a circuit diagram of an imaging portion 103 in the Embodiment 2. The BLD_SW terminal is connected to the capacitor C50 via a resistor R54. Between a connected point of the resistor R54 and the capacitor C50 and the GND, a capacitor C52 is connected. By this, between the BLD_SW terminal and the capacitor C50, a low pass filter 71 constituted by the resistor R54 and the capacitor C52 is formed. The low pass filter 71 is connected between the capacitor C50 and the control portion 200, and functions as a first low pass which allows a frequency with a third frequency, higher than the first frequency, or lower to pass through.

Similarly, the BLD_SW terminal is connected via a resistor R64 to the capacitor C60. Between a connected point of the resistor R64 and the capacitor C60 and the GND, a capacitor C62 is connected. By this, between the BLD_SW terminal and the capacitor C60, a low pass filter 72 constituted by the resistor R64 and the capacitor C62 is formed. The low pass filter 72 is connected between the capacitor C60 and the control portion 200, and functions as a second low pass which allows a frequency with a fourth frequency, higher than the first frequency and lower than the third frequency, or lower to pass through.

The low pass filter 71 has characteristics that allow the pulse signal with a predetermined frequency f3 (third frequency), which is determined by the resistor R54 and the capacitor C52, or lower to pass through and cut off the pulse signal with a frequency higher than the predetermined frequency f3. The low pass filter 72 has characteristics that allow the pulse signal with a predetermined frequency f4 (fourth frequency), which is determined by the resistor R64 and the capacitor C62, or lower to pass through and cut off the pulse signal with a frequency higher than the predetermined frequency f4. As an example, the capacitor C50 and the capacitor C60, as well as the low pass filter 71 and the low pass filter 72 are designed so that each predetermined frequency has a relationship of f2<f1<f4<f3.

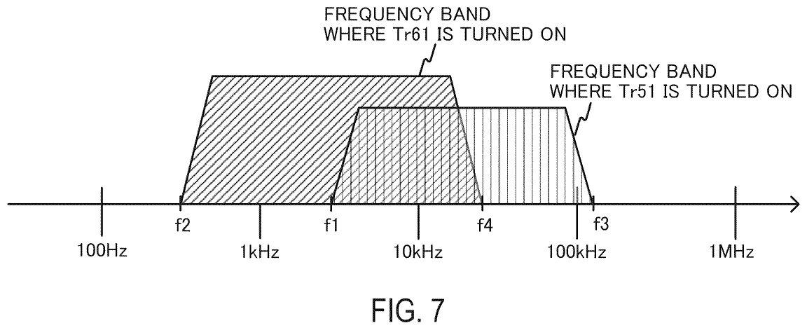

Next, using FIG. 7, states of the transistor Tr51 and the transistor Tr61 with respect to the frequency f of the pulse signal output from the BLD_SW terminal will be described. The state of the transistor Tr51 is determined by the frequency of the pulse signal and the filter characteristics of the low pass filter 71 and the capacitor C50. The pulse signal with the predetermined frequency f3, which is determined by the low pass filter 71, or lower and the predetermined frequency f1, which is determined by the capacitor C50, or higher (f1≤f≤f3) passes through the capacitor C50. The pulse signal with a higher frequency than the predetermined frequency f3 (f>f3) or a lower frequency than the predetermined frequency f1 (f<f1) does not pass through the capacitor C50. In other words, the transistor Tr51 is turned on when the pulse signal has the frequency f between the predetermined frequency f3 and the predetermined frequency f1, and is not turned on when the pulse signal has the frequency f higher than the predetermined frequency f3 or the frequency f lower than the predetermined frequency f1.

Similarly, the state of the transistor Tr61 is determined by the frequency of the pulse signal and the filter characteristics of the low pass filter 72 and the capacitor C60. The pulse signal with the predetermined frequency f4, which is determined by the low pass filter 72, or lower and the predetermined frequency f2, which is determined by the capacitor C60, or higher (f2≤f≤f4) passes through the capacitor C60. The pulse signal with a higher frequency than the predetermined frequency f4 (f>f4) or a lower frequency than the predetermined frequency f2 (f<f2) does not pass through the capacitor C60. In other words, the transistor Tr61 is turned on when the pulse signal has the frequency f between the predetermined frequency f4 and the predetermined frequency f2, and is not turned on when the pulse signal has the frequency f higher than the predetermined frequency f4 or the frequency f lower than the predetermined frequency f2.

That is, the frequency higher than the predetermined frequency f3 is cut off by the low pass filter 71, and the frequency higher than the predetermined frequency f4 is cut off by the low pass filter 72. Therefore, as shown in FIG. 7, upon the frequency in the predetermined range, the transistors Tr51 and Tr61 are turned on, respectively. Incidentally, in a case in which the frequency f of the pulse signal is higher than the predetermined frequency f3, since the passing through of the pulse signal is cut off by the low pass filter 71 and the low pass filter 72, the transistor Tr51 and the transistor Tr61 are turned off.

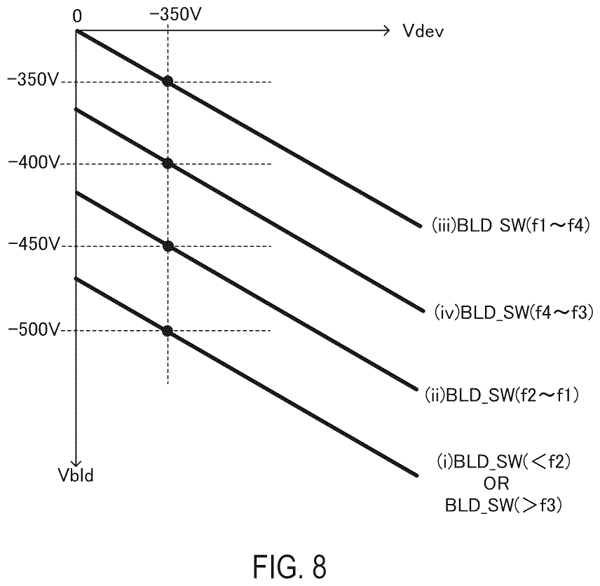

Next, relationship between the developing voltage Vdev and the blade voltage Vbld is shown in FIG. 8. In FIG. 8, a horizontal axis represents a value of the developing voltage Vdev and a vertical axis represents a value of the blade voltage Vbld. (i) through (iv) in FIG. 8 correspond to the following (i) through (iv).

### (i) The Transistor Tr51 and the Transistor Tr61 are Off

When the frequency f of the pulse signal output from the BLD_SW terminal has a frequency lower than the predetermined frequency f2 (for example, 100 Hz), the transistor Tr51 and the transistor Tr61 are turned off. Therefore, the blade voltage Vbld becomes lower than the developing voltage Vdev by the sum of the Zener diode ZD61 and the Zener diode ZD51. In other words, when the developing voltage Vdev is −350V, the blade voltage Vbld becomes −500 V. In addition, also when the pulse signal is not output or when the pulse signal is a Low output (Lo state) or a High output (Hi state), it becomes the state of (i). Furthermore, also when the frequency f of the pulse signal is higher than the predetermined frequency f3, it becomes the state of (i).

### (ii) The Transistor Tr51 is Off and the Transistor Tr61 is On

When the frequency f of the pulse signal output from the BLD_SW terminal is the predetermined frequency f2 or higher and lower than the predetermined frequency f1 (for example, 1 kHz), the transistor Tr51 is turned off and the transistor Tr61 is turned on. Since the Zener diode ZD61 is short-circuited, the blade voltage Vbld becomes lower than the developing voltage Vdev by the Zener voltage of the zener diode ZD51. In other words, when the developing voltage Vdev is −350 V, the blade voltage Vbld becomes −450 V.

(iii) The Transistor Tr51 is On and the Transistor Tr61 is On

When the frequency f of the pulse signal output from the BLD_SW terminal is the predetermined frequency f1 or higher and the predetermined frequency f4 or lower (for example, 10 kHz), the transistor Tr51 is turned on and the transistor Tr61 is turned on. Since the Zener diode ZD51 and the Zener diode ZD61 are short-circuited, the blade voltage Vbld becomes the same potential as the developing voltage Vdev. In other words, when the developing voltage Vdev is −350 V, the blade voltage Vbld becomes −350 V.

### (iv) The Transistor Tr51 is On and the Transistor Tr61 is Off

When the frequency f of the pulse signal output from the BLD_SW terminal is higher than the predetermined frequency f4 and the predetermined frequency f3 or lower (for example, 100 kHz), the transistor Tr51 is turned on and the transistor Tr61 is turned off. Since the Zener diode ZD51 is short-circuited, the blade voltage Vbld becomes lower than the developing voltage Vdev by the Zener voltage of the Zener diode ZD61. In other words, when the developing voltage Vdev is −350 V, the blade voltage Vbld becomes −400 V.

Through the operation described above, for the developing blade 135a, it becomes possible to use with switching among the four kinds of voltages. First, the voltage which is the same as the developing voltage Vdev, and the voltage of which the absolute value is greater than the developing voltage Vdev by the sum of the Zener voltages of the Zener diode ZD51 and the Zener diode ZD61. In addition, the voltage of which the absolute value is greater than the developing voltage Vdev by the Zener diode ZD51, and the voltage of which the absolute value is greater than that of the developing voltage Vdev by the Zener voltage of the Zener diode ZD61. In the Embodiment 2, since it becomes possible to switch among the four kinds of voltages, depending on the value of the environment sensor 170, it becomes possible to set the potential difference between the developing voltage Vdev and the blade voltage Vbld more finely. By this, the control portion 200 controls, depending on the detection result of the environment sensor 170, the transistors Tr51 and Tr61 so as to be (i) in the normal environment, (ii) in the high temperature and high humidity environment, and (iii) in the case in which the rotation of the developing roller 133a is stopped, respectively. In addition, based on the detection result of the environment sensor 170, in a case of an environment such as between the normal environment and the high temperature and high humidity environment, the control portion 200 controls the transistors Tr51 and Tr61 so as to be (iv).

In this manner, the control portion 200 sets, in a case in which the value detected by the environment sensor 170 is a first predetermined value or smaller (for example, the normal environment), the frequency of the output pulse signal to be lower than the second frequency. By this, the control portion 200 switches so that the potential difference between the developing voltage Vdev and the blade voltage Vbld is the sum of the first value (100 V) and the second value (50 V). In addition, in a case in which the value detected by the environment sensor 170 is greater than a second predetermined value which is greater than the first predetermined value (for example, the high temperature and high humidity environment), the control portion 200 sets the frequency of the output pulse signal to be the second frequency or higher and lower than the first frequency, and switches so that the potential difference is the first value. In addition, in a case in which the value detected by the environment sensor 170 is greater than the first predetermined value and smaller than the second predetermined value (the environment between the normal environment and the high temperature and high humidity environment), the control portion 200 sets the frequency of the output pulse signal to be higher than the fourth frequency and the third frequency or lower. By this, the control portion 200 switches so that the potential difference is the second value.

As described above, in the Embodiment 2, for the developing blade 135 a, by using with switching among the four kinds of voltages depending on the use environment, it becomes possible to suppress the image defect. First, the voltage which is the same as the developing voltage Vdev, and the voltage of which the absolute value is greater than that of the developing voltage Vdev by the sum of the Zener voltages of the Zener diode ZD51 and the Zener diode ZD61. In addition, the voltage of which the absolute value is greater than the developing voltage Vdev by the Zener diode ZD51, and the voltage of which the absolute value is greater than that of the developing voltage Vdev by the Zener voltage of the Zener diode ZD61.

The control portion 200 switches, by setting the frequency of the output pulse signal to be higher than the fourth frequency and the third frequency or lower (f4<f≤f3), so that the potential difference between the developing voltage Vdev and the blade voltage Vbld is the second value (50 V) with the switching circuits 81 and 82. More specifically, the control portion 200 causes, by setting the frequency of the output pulse signal to be higher than the fourth frequency and the third frequency or lower, the transistor Tr51 to be the on state and the transistor Tr61 to be the off state, and switches so that the potential difference is the second value (50 V). In addition, the control portion 200 switches, by setting the frequency of the output pulse signal to be the first frequency or higher and the fourth frequency or lower (f1≤f≤f4), so that the potential difference is zero with the switching circuits 81 and 82. More specifically, the control portion 200 causes, by setting the frequency of the output pulse signal to be the first frequency or higher and the fourth frequency or lower, the transistors Tr51 and Tr61 to be the on state, and switches so that the potential difference is zero. Incidentally, also in the Embodiment 2, the Zener diodes ZD51 and ZD61 may be replaced by the resistors R53 and R63. In addition, other switching elements may be used instead of the transistors.

As described above, according to the Embodiment 2, it becomes possible, with the inexpensive circuit configuration, to switch the potential difference between the developing roller and the developing blade.

According to the present invention, it becomes possible, with the inexpensive circuit configuration, to switch the potential difference between the developing roller and the developing blade.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-215484, filed on Dec. 10, 2024, which is hereby incorporated by reference herein in its entirety.

What is claimed is:

1. An image forming apparatus comprising:
a photosensitive member on which an electrostatic latent image is formed;
a developing roller configured to develop the electrostatic latent image by supplying toner to the photosensitive member;
a contacting member configured to contact a surface of the developing roller; and
an electronic power source configured to output a first voltage,
wherein a second voltage generated by using the first voltage is applied to the developing roller,
wherein a third voltage generated by using the second voltage is applied to the contacting member,
wherein the electric power source includes
a control portion provided with an output terminal for outputting a signal to switch a potential difference between the second voltage and the third voltage,
a first coupling portion connected in series to the output terminal and configured to allow only the signal with a first frequency or higher to pass through,
a second coupling portion connected in series to the output terminal and configured to allow only the signal with a second frequency, lower than the first frequency, or higher to pass through,
a first switching circuit connected in series to the first coupling portion and configured to switch the potential difference by receiving the signal which has passed through the first coupling portion, and
a second switching circuit connected in series to the second coupling portion and configured to switch the potential difference by receiving the signal passed through the second coupling portion,
wherein the control portion switches the potential difference to any of three or more kinds of values by changing a frequency of the signal outputted to the first coupling portion and the second coupling portion.

2. The image forming apparatus according to claim 1, wherein in a case in which the first switching circuit shifts from a state of receiving the signal to a state of non-receiving the signal, the first switching circuit switches the potential difference so that the potential difference is increased by a first value,
wherein in a case in which the first switching circuit shifts from the state of non-receiving the signal to the state of receiving the signal, the first switching circuit switches the potential difference so that the potential difference is decreased by the first value,
wherein in a case in which the second switching circuit shifts from the state of receiving the signal to the state of non-receiving the signal, the second switching circuit switches the potential difference so that the potential difference is increased by a second value, and
wherein in a case in which the second switching circuit shifts from the state of non-receiving the signal to the state of receiving the signal, the second switching circuit switches the potential difference so that the potential difference is decreased by the second value.

3. The image forming apparatus according to claim 2, wherein the first switching circuit includes a first voltage drop element and a first switching element connected in parallel to the first voltage drop element,
wherein the second switching circuit includes a second voltage drop element and a second switching element connected in parallel to the second voltage drop element,
wherein in the case in which the first switching circuit shifts from the state of receiving the signal to the state of non-receiving the signal, the first voltage drop element generates the potential difference by the first value by the first switching element becoming an off state,
wherein in the case in which the first switching circuit shifts from the state of non-receiving the signal to the state of receiving the signal, the first voltage drop element is short-circuited by the first switching element becoming an on state,
wherein in the case in which the second switching circuit shifts from the state of receiving the signal to the state of non-receiving the signal, the second voltage drop element generates the potential difference by the second value by the second switching element becoming an off state, and
wherein in the case in which the second switching circuit shifts from the state of non-receiving the signal to the state of receiving the signal, the second voltage drop element is short-circuited by the second switching element becoming an on state.

4. The image forming apparatus according to claim 1, further comprising:
a first low pass filter connected between the first coupling portion and the control portion and configured to allow only the signal with a third frequency, higher than the first frequency, or lower to pass through, and
a second low pass filter connected between the second coupling portion and the control portion and configured to allow only the signal with a fourth frequency, higher than the first frequency and lower than the third frequency, or lower to pass through,
wherein the first switching circuit switches the potential difference by receiving the signal which has passed through the first coupling portion and the first low pass filter,
wherein the second switching circuit switches the potential difference by receiving the signal which has passed through the second coupling portion and the second low pass filter,
wherein in a case in which the first switching circuit shifts from a state of receiving the signal to a state of non-receiving the signal, the first switching circuit switches the potential difference so that the potential difference is increased by a first value,
wherein in a case in which the first switching circuit shifts from the state of non-receiving the signal to the state of receiving the signal, the first switching circuit switches the potential difference so that the potential difference is decreased by the first value,
wherein in a case in which the second switching circuit shifts from the state of receiving the signal to the state of non-receiving the signal, the second switching circuit switches the potential difference so that the potential difference is increased by a second value, and
wherein in a case in which the second switching circuit shifts from the state of non-receiving the signal to the state of receiving the signal, the second switching circuit switches the potential difference so that the potential difference is decreased by the second value.

5. The image forming apparatus according to claim 4, wherein the first switching circuit includes a first voltage drop element and a first switching element connected in parallel to the first voltage drop element,
wherein the second switching circuit includes a second voltage drop element and a second switching element connected in parallel to the second voltage drop element,
wherein in the case in which the first switching circuit shifts from the state of receiving the signal to the state of non-receiving the signal, the first voltage drop element generates the potential difference by the first value by the first switching element becoming off state,
wherein in the case in which the first switching circuit shifts from the state of non-receiving the signal to the state of receiving the signal, the first voltage drop element is short-circuited by the first switching element becoming to an on state,
wherein in the case in which the second switching circuit shifts from the state of receiving the signal to the state of non-receiving the signal, the second voltage drop element generates the potential difference by the second value by the second switching element becoming an off state, and
wherein in the case in which the second switching circuit shifts from the state of non-receiving the signal to the state of receiving the signal, the second voltage drop element is short-circuited by the second switching element becoming an on state.

6. The image forming apparatus according to claim 3, wherein the first switching element is any one of a transistor, a field effect transistor or a photocoupler, and
wherein the second switching element is any one of a transistor, a field effect transistor or a photocoupler.

7. The image forming apparatus according to claim 1, wherein the contacting member is a developing blade configured to adjust an amount of toner carried by the developing roller.

8. The image forming apparatus according to claim 1, further comprising a charging roller configured to charge the photosensitive member,
wherein the first voltage is applied to the charging roller.

9. The image forming apparatus according to claim 1, further comprising an environment sensor configured to detect at least one of a temperature and a humidity,
wherein the control portion changes the frequency of the signal according to a detection result of the environment sensor.

10. The image forming apparatus according to claim 9, wherein the control portion changes the frequency of the signal so as to reduce the potential difference in a case in which a value detected by the environment sensor is higher than a predetermined value.
